(19) United States
(12) Patent Application Publication
(10) Pub. No.: US 2009/0094988 A1
(43) Pub. Date: Apr. 16, 2009

(54) MULTI-CYCLE UNDERSEA POWER SYSTEM

(76) Inventor: PAUL M. DUNN, West Kingston, RI (US)

Correspondence Address: NAVAL UNDERSEA WARFARE CENTER;DIVISION NEWPORT, 1176 HOWELL STREET, CODE 000C, NEWPORT, RI, 02841, US

(21) Appl. No.: 11/871,315

(22) Filed: Oct. 12, 2007

(51) Int. Cl. F02B 51/00

(52) U.S. Cl. 60/772; 123/1 A; 60/273

(57) ABSTRACT

A method of operating an internal combustion engine, such as a diesel engine, includes an air cycle and an exhaust cycle. During the air cycle, atmospheric air and fuel are combusted within the engine. During the exhaust cycle, no atmospheric air is introduced into the engine. Instead, exhaust gas is recirculated into to the engine. The exhaust gas provides a working fluid for a compression ignition cycle and the fuel is capable of air-independent combustion.

### STATEMENT OF GOVERNMENT INTEREST

The invention described herein may be manufactured and used by or for the Government of the United States of America for governmental purposes without the payment of any royalties thereon or therefore.

### CROSS REFERENCE TO OTHER RELATED APPLICATIONS

None.

### BACKGROUND OF THE INVENTION

(1) Field of the Invention

The present invention relates to the operation of internal combustion engines, and more particularly to an air and an exhaust cycle for operating diesel engines.

(2) Description of the Prior Art

Unmanned Undersea Vehicles (UUVs) and non-nuclear submersibles are generally powered by two internal combustion engine cycles (a closed cycle and an open cycle). Internal combustion engines operating in the open cycle require a propellant or fuel (such as gasoline or diesel fuel) and air (such as atmospheric air) for combustion to take place. Open cycle engines have an obvious limitation in that the engines need a constant and large supply of air, thus preventing a UUV using an open cycle internal combustion engine from submerging for an extended period of time. An internal combustion engine operating in a closed cycle does not require the use of air.

Since conventional fuels, such as gasoline and diesel fuel, require oxygen to combust, special fuels are required for internal combustion engines to operate in a closed cycle. One example of such a fuel is Otto Fuel II (a nitrate ester comprising mostly propylene glycol di-nitrate).

Internal combustion engines operating in closed cycles generally have higher specific fuel consumption compared to similarly-sized internal combustion engines operating in open cycles. For example, a diesel engine operating in an open cycle generates approximately 20 times the amount of power per pound of fuel as compared to a similarly-sized diesel engine operating on Otto Fuel. As a result, UUVs operating in a closed cycle have a much smaller operating range as compared to UUVs operating in an open cycle.

Accordingly, what is needed is a method of operating an internal combustion engine in an air-independent manner, but when air is available, the operating efficiency of the internal combustion engine increases.

### SUMMARY OF THE INVENTION

The present invention features a method of operating an internal combustion engine, preferably a diesel engine (compression ignition engine), in, at least, a semi-closed or an “exhaust” cycle. The exhaust cycle includes generating an exhaust gas, introducing a fuel into the internal combustion engine, mixing a portion of the exhaust gas from the internal combustion engine with the fuel, and combusting the mixture of the exhaust gas and the fuel. The exhaust cycle is semi-closed in that no atmospheric air is introduced into the internal combustion engine. The internal engine may preferably be switched back and forth from the exhaust cycle to an open or an “air” cycle. The air cycle includes mixing atmospheric air and fuel in the internal combustion engine and combusting the mixture of atmospheric air and fuel.

The fuel can be Otto Fuel II (nitrate ester comprising mostly propylene glycol di-nitrate), another monopropellant, or a fuel rich blend of oxidizers and fuel similar to nitric acid beta picoline. In the preferred embodiment, the internal combustion engine is connected to a generator to produce electricity.

### BRIEF DESCRIPTION OF THE DRAWINGS

These and other features and advantages of the present invention will be better understood in view of the following description of the invention taken together with the drawings wherein:

FIG. 1 is a schematic view of the present invention; and

FIG. 2 is a schematic view of a first variant of the present invention.

### DETAILED DESCRIPTION OF THE INVENTION

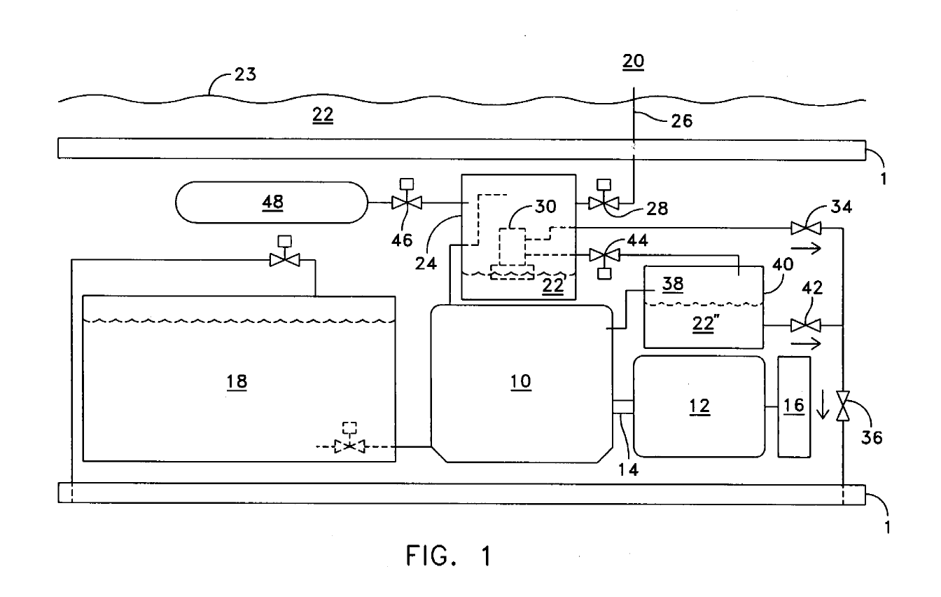

In FIG. 1, a vessel 1 includes a conventional internal combustion engine 10, preferably a diesel engine, mechanically coupled 14 to a conventional generator 12 in any manner known to those skilled in the art. The vessel 1 preferably includes a battery 16 connected to the generator 12 for storing energy produced by the internal combustion engine 10 and the generator.

During normal operation (to be identified as an “air” cycle for purposes of this description/disclosure), the internal combustion engine 10 operates in the air cycle (air burning) wherein fuel 18 and air 20 are combusted in the internal combustion engine 10 in the manner known to those skilled in the art. This cycle requires a constant and abundant supply of the air 20, thus requiring the vessel 1 to be relatively close to a water surface 23 so that air may be drawn into the internal combustion engine 10 through a snorkel 26 or another similar apparatus.

For exemplary purposes only and during normal operation, the air 20 is drawn through the snorkel 26 and an air inlet valve 28 and into an air box 24. Water 22 that is entrained with the air 20 is collected in the air box 24 and is discharged overboard by an air inlet box drain pump 30 (similar to a bilge pump) and primary 34 and secondary 36 air box check valves.

The air 20 from the air box 24 is then introduced into the internal combustion engine 10 by any manner known to those skilled in the art such as, but not limited to, turbo charging, supercharging, or natural aspiration where the air 20 is mixed with the fuel 18 and combusted in the traditional manner.

Engine exhaust gas 38 produced by the combustion of the air 20 and the fuel 18 is mixed with the cooling effects of the water 22 in a muffler and exhaust box 40. The cooled exhaust gas 38 and the water 22 are then discharged via an engine exhaust primary valve 42 and the secondary air box check valve 36. It should be understood that many different variations of the air cycle embodiment described above are contemplated, and that the embodiment described above is for exemplary purposes only and is not intended to limit the scope of the present invention.

When the air 20 is not available, for example when the vessel 1 is submerged such that the snorkel 26 is beneath the water surface 23, the vessel may be powered solely by the battery 16 or by the internal combustion engine 10 operating in an “exhaust” cycle (air independent). During the semi-closed cycle (identified as an “exhaust cycle” for purposes of this description/disclosure), none of the air 20 is drawn into the air box 24 or the internal combustion engine 10. Instead, a portion of the engine exhaust gas 38 is introduced into the internal combustion engine 10 as inert working fluid.

Although the exhaust gas 38 has a lower specific heat ratio than air; nominally 1.2-1.3 rather than 1.4, the compression ignition cycle of the engine 10 will still work using exhaust gas as the working fluid for at least two reasons: 1) the working fluid is at a higher initial temperature, and 2) the monopropellant fuel (such as Otto Fuel II) has a lower ignition temperature.

For exemplary purposes only, the internal combustion engine 10 may be converted from the air cycle to the exhaust cycle by closing the air inlet valve 28 and opening an exhaust gas recirculating valve 44. Furthermore, if the internal combustion engine 10 is required to start while the vessel 1 submerged, a gas valve 46 may be opened to allow gas 48 (such as nitrogen or argon) to flow into the air box 24, thus providing the initial gas supply for the internal combustion engine 10. The gas 48 may also be used to blow out any of the water 22 that is entrapped within the snorkel 26 when vessel resurfaces.

The requirement for the fuel 18 is that it contains sufficient oxidizer to combust without air, but that it be “fuel rich”, i.e., only partially oxidized when burned without air. As a result, the engine efficiency can increase (specific fuel consumption decrease), when air is available. Blends of nitric acid, hydroxyl ammonium nitrate, hydroxyl ammonium perchorate, perchorlic acid and soluble fuel, e.g., glycol, alcohols, or biela piccoline would be possible.

The fuel 18 may include various “fuel rich” monopropellants. In the description of the invention, the fuel 18 is a nitrate ester containing mostly Propylene Glycol Di-Nitrated (PGDN) such as Otto Fuel II.

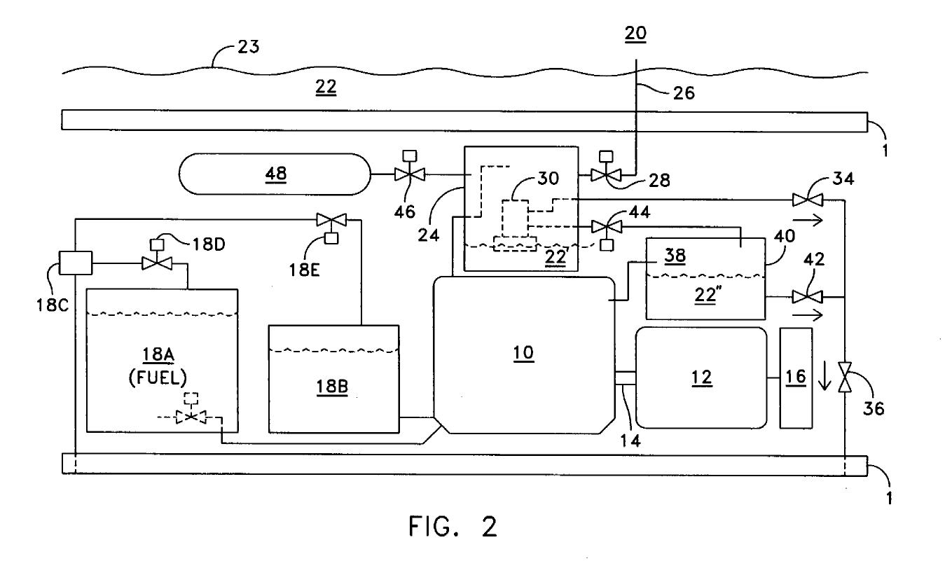

In a first variant of the present invention, depicted in FIG. 2, a bi-propellant system is provided. The bi-propellant variant requires a fuel tank 18A and a fuel tank 18B. If the fuel has a soluble oxidizer and a fuel component such as alcohol and acid, then the blend of fuel could be varied whether air was available or not; transitioning from fuel only with air, to fuel/oxygen with air, to fuel/oxygen with exhaust gas. The variant includes a fuel tank 18A, an oxidizer 18B and a mixing valve 18C. Each tank 18A and 18B is respectively supplied with a cutoff valve 18D and 18E.

It will be understood that many additional changes in details, materials, steps and arrangement of parts which have been described herein and illustrated in order to explain the nature of the invention, may be made by those skilled in the art within the principle and scope of the invention as expressed in the appended claims.

What is claimed is:

1. A method of operating an internal combustion engine in an exhaust gas cycle, said exhaust gas cycle comprising:
generating an exhaust gas;
recirculating a portion of the exhaust gas from the internal combustion engine as a working fluid; and
combusting fuel in the working fluid;
operating the internal combustion engine subsequent to said combusting step.

2. The method in accordance with claim 1 wherein said method further comprises a step of switching the internal combustion engine from the exhaust gas cycle to an air cycle, said switching step including the steps of:
introducing atmospheric air into the internal combustion engine;
introducing the fuel into the internal combustion engine; and
combusting a mixture of the atmospheric air and the fuel.

3. The method in accordance with claim 2 wherein the internal combustion engine is a diesel engine.

4. The method in accordance with claim 3 wherein the fuel is a fuel rich monopropellant.

5. The method in accordance with claim 4 wherein the monopropellant is a nitrate ester with propylene glycol di-nitrate.

6. The method in accordance claim 3 wherein the fuel is a fuel rich oxidizer/fuel mixture.

7. The method in accordance with claim 3 wherein an oxidizer is mixed with the fuel with a mixing valve.
